(19) United States
(12) Patent Application Publication
(10) Pub. No.: US 2017/0046754 A1
(43) Pub. Date: Feb. 16, 2017

(54) COMPOUND-PRICE CALCULATING SYSTEM AND METHOD THEREOF

(71) Applicant: MOLBASE (Shanghai) Biotechnology Co., Ltd., Shanghai (CN)

(72) Inventor: Jun WEN, Shanghai (CN)

(21) Appl. No.: 14/861,241

(22) Filed: Sep. 22, 2015

Related U.S. Application Data
(60) Provisional application No. 62/204,893, filed on Aug. 13, 2015.

(51) Int. Cl. G06Q 30/02

(52) U.S. Cl. CPC G06Q 30/0283

(57) ABSTRACT

A compound-price calculating system includes a compound synthetic pathway base, a historical transaction base, and a price calculating system. The method involves computing a current cost price of a target compound based on historical trade prices or current supplier's offers of the upstream compound of the target compound; computing a synthetic pathway price of the target compound based on costs of upstream compounds and a yield of the target compound; computing a total pathway price ratio; and obtaining a final suggested price of the target compound. The system and method provide authentic reference on prices for users' transactions. With addition of new information about synthetic pathways and the Internet's autonomous learning ability, the price data can be continuously updated. It is about using synthetic pathways and vertical historical prices to build a solid two-dimensional system for price expectation.

### BACKGROUND OF THE INVENTION

1. Technical Field

The present invention relates to smart methods for calculating commodity prices for third-party platforms, and more particularly to a compound-price calculating system and its method.

2. Description of Related Art

With the rapid development of electronic commerce, there are more and more vertical search fields. Globally, the annual growth of the compound market is a high as 20%˜30%. However, compound transactions are currently still managed by trading companies in the traditional way. A compound's market price remains a mystery to both its buyers and suppliers. The market is least transparent. Before a deal is done, the buyer and the supplier have to spend considerable time on inquiry and parity. Also, in the traditional market, for maximizing profits, suppliers are usually unwilling to disclose their prices to the public. Thus, though it is possible to collect abundant information about compounds and their suppliers through the Internet, the information on prices is unknown.

Current, search engines and e-commerce platforms are open to provide useful commodity information. With proper combinations of search criteria, a user can rapidly get information about his/her target commodity, such as the names and contacts of suppliers, the properties of the commodity and other detailed descriptions. However, in many third-party platforms, the information about prices, which is what users concern most, is unavailable for some reasons. In some other cases, the suppliers may provide untruthful information, making the acquired price information far from the actual market prices. Since the suppliers are unaware of the prevalent market prices, they tend to disclose untrue prices or hide prices, and buyers thus have no confidence in such commodity information. As a result, even though a buy has spent a lot of time to ask for quotations and do comparison, he/she may still fail to buy the commodity he/she needs at a reasonable price. In general, this affects commodity transactions adversely.

### SUMMARY OF THE INVENTION

One objective of the present invention is to address the shortcomings seen in the prior art by providing a compound-price calculating system and a method thereof.

The first objective of the present invention is to provide a compound-price calculating system that comprises:

a compound synthetic pathway base, recording upstream and downstream products of a compound and prices, synthetic pathways, synthetic conditions and yields of the upstream and downstream products;

a historical transaction base, recording trade commodities, times and prices of all transactions and current supplier's offer of each said commodity; and

a price calculating system, storing equations for calculating compound current cost price, synthetic pathway price, standard synthetic pathway prices, single pathway price ratios, total pathway price ratios and suggested prices.

The second objective of the present invention is to provide a compound-price calculating method that at least comprises the following steps:

(1) computing a current cost price of a target compound based on historical trade prices or current supplier's offers of the upstream compound of the target compound;

(2) where the target compound has multiple synthetic pathways, computing synthetic pathway prices of the target compound based on the costs of the upstream compounds and the yields of the target compound of all the synthetic pathways, and selecting the lowest synthetic pathway price as a standard synthetic pathway price;

(3) according to the standard synthetic pathway price and the current cost price, computing a single pathway price ratio, which is a proportion of the standard synthetic pathway price to the current cost price; and according to the multiple said single pathway price ratios, computing a total pathway price ratio; and

(4) obtaining a final suggested price of the target compound from the standard synthetic pathway price and the total pathway price ratio.

In the compound-price calculating method as described previously, Step (1) further comprising: computing an average of the multiple historical trade prices of the upstream compounds as a standard historical trade price of the target compound:

Standard Historical Trade Price=Sum(Historical Trade Price 1+Historical Trade Price 2+ . . . +Historical Trade Price n)/(n);

computing an average of the multiple supplier's offers of the upstream compounds as a standard supplier's offer of the target compound:

Standard supplier's offer=sum(Supplier's Offer 1+Supplier's Offer 2+ . . . +Supplier's Offer n)/(n); and

taking the standard historical trade price or the standard supplier's offer as the current cost price of the target compound.

In the compound-price calculating method as described previously, in Step (2) the synthetic pathway price of the target compound is computed as below:

Synthetic Pathway Price=Sum(Compound's Cost Price 1+Compound's Cost Price 2+ . . . +Compound's Cost Price n)*(1−Yield %)/(n);

the standard synthetic pathway price of the target compound is computed as below:

Standard synthetic pathway price=min (synthetic pathway price 1, synthetic pathway price 2, synthetic pathway price 3, . . . ).

In the compound-price calculating method as described previously, in Step (3) single pathway price ratio=Standard synthetic pathway price/Historical trade price; and

total pathway price ratio=sum(single pathway price ratio 1+single pathway price ratio 2+ . . . +single pathway price ratio n)/(n).

In the compound-price calculating method as described previously, in Step (4) the suggested price is obtained from the equation of:

Suggested Price=Standard Synthetic Pathway Price/Total Pathway Price Ratio.

To sum up, the present invention uses the compound synthetic pathway base to record the upstream and downstream products, synthetic procedures, synthetic conditions and yields of compounds. By considering and analyzing to the known prices of the upstream raw-material compound and the yield of the target commodity compound, and other price-affecting factors that influence the price, the cost price of the target commodity can be obtained. In addition, with the evolving historical transaction base, it is possible to recognize the trend of the trade prices of the related commodities, and in turn reasonably calculate the current market price. The system and method provide authentic reference on prices for users' transactions based on the cost process and the current market trade prices.

With addition of new information about synthetic pathways and the Internet's autonomous learning ability, the price data can be continuously updated. It is about using synthetic pathways and vertical historical prices to build a solid two-dimensional system for price expectation.

### BRIEF DESCRIPTION OF THE DRAWINGS

FIG. 1 is a flowchart of a compound-price calculating system and its method according to the present invention;

FIG. 2 is a schematic diagram illustrating the relation between upstream compounds and a target compound according to the present invention.

### DETAILED DESCRIPTION OF THE INVENTION

The following description, in conjunction with the accompanying drawings and preferred embodiments, is set forth as below to illustrate the implement, structure, features and effects of the subject matter of the present invention.

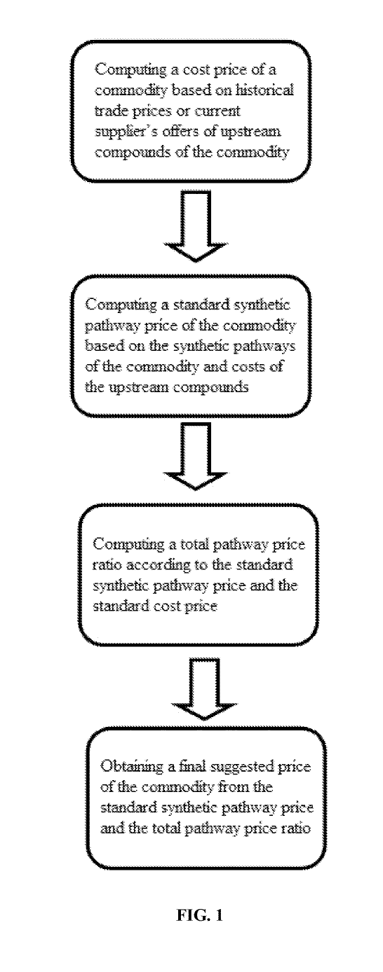

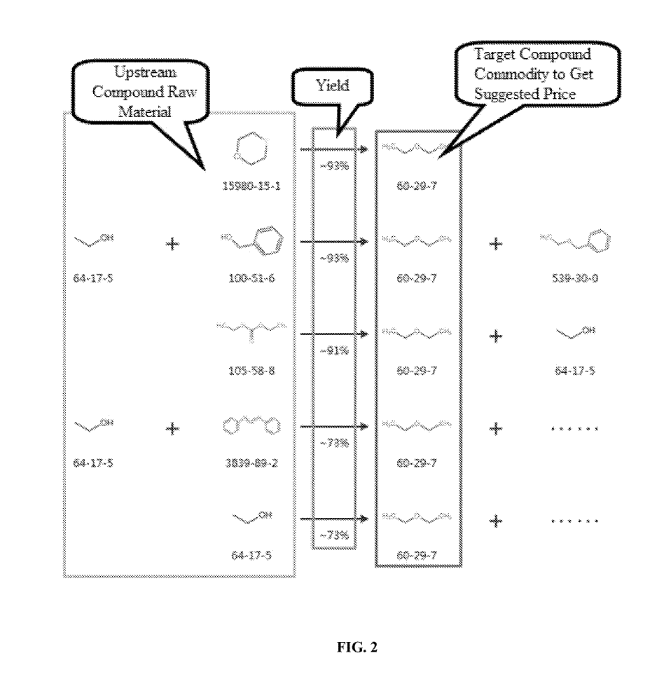

Referring to FIG. 1 and FIG. 2, the present invention provides a compound-price calculating system that comprises a compound synthetic pathway base, a historical transaction base and a price calculating system.

The compound synthetic pathway base records upstream and downstream products of a compound and prices, synthetic pathways, synthetic conditions and yields of the upstream and downstream products.

The historical transaction base records trade commodities, times and prices of all transactions and current supplier's offer of each said commodity.

The price calculating system stores equations for calculating compound current cost price, synthetic pathway price, standard synthetic pathway prices, single pathway price ratios, total pathway price ratios and suggested prices.

According to the present invention, a compound-price calculating method involves:

In a first step (1), by computing an average of multiple historical trade prices of the upstream compounds, the standard historical trade price of the target compound can be obtained:

Standard Historical Trade Price=Sum(Historical Trade Price 1+Historical Trade Price 2+ . . . +Historical Trade Price n)/(n).

Then by computing an average of the multiple supplier's offers of the upstream compounds, the standard supplier's offer of the target compound can be obtained:

Standard Supplier's Offer=Sum(Supplier's Offer 1+Supplier's Offer 2+ . . . +Supplier's Offer n)/(n).

The standard historical trade price or the standard supplier's offer is taken as the current cost price of the target compound. Since the historical trade price is relatively reliable, where there are historical trade prices available, the standard historical trade price is taken as the current cost price of the target compound. If there is no historical trade price available, the supplier's current offer is taken to compute the current cost price.

In a second step (2), where the target compound has multiple synthetic pathways, synthetic pathway prices of the target compound are computed based on the costs of the upstream compounds and the yields of the target compound of all the synthetic pathways. Then the lowest synthetic pathway price is taken as a standard synthetic pathway price.

The synthetic pathway price of the target compound is computed as below:

Synthetic Pathway Price=Sum(Compound's Cost Price 1+Compound's Cost Price 2+ . . . +Compound's Cost Price n)*(1−Yield %)/(n);

The standard synthetic pathway price of the target compound is computed as below:

Standard Synthetic Pathway Price=Min (Synthetic Pathway Price 1, Synthetic Pathway Price 2, Synthetic Pathway Price 3, . . . ).

Then is a third step (3). It is to be noted that in addition to the costs of the upstream materials, there are various factors affecting the actual price of a compound, such as labor costs, machine loss, environment handling and market situation. The present invention herein defines a ratio after comparing a huge amount of synthetic pathway prices and commodity actual prices, which is a proportion of the synthetic pathway price to the total cost, and is herein referred to as a “single pathway price ratio”.

According to the standard synthetic pathway price and the current cost price, the single pathway price ratio is computed:

Single Pathway Price Ratio=Standard synthetic pathway price/Historical trade price.

According to multiple single pathway price ratios, a total pathway price ratio is obtained:

total pathway price ratio=sum(single pathway price ratio 1+single pathway price ratio 2+ . . . +single pathway price ratio n)/(n).

In a fourth step (4), according to the standard synthetic pathway price and the total pathway price ratio, a suggested market price of the target compound that is relatively authentic can be obtained. The equation for computing the final suggested price is:

Suggested Price=Standard synthetic pathway price/total pathway price ratio.

To sum up, the present invention uses the compound synthetic pathway base to record the upstream and downstream products, synthetic procedures, synthetic conditions and yields of compounds. By considering and analyzing to the known prices of the upstream raw-material compound and the yield of the target commodity compound, and other price-affecting factors that influence the price, the cost price of the target commodity can be obtained. In addition, with the evolving historical transaction base, it is possible to recognize the trend of the trade prices of the related commodities, and in turn reasonably calculate the current market price. The system and method provide authentic reference on prices for users' transactions based on the cost process and the current market trade prices.

With addition of new information about synthetic pathways and the Internet's autonomous learning ability, the price data can be continuously updated. It is about using synthetic pathways and vertical historical prices to build a solid two-dimensional system for price expectation.

The present invention has been described with reference to the preferred embodiments and it is understood that the embodiments are not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A compound-price calculating system, comprising:
a compound synthetic pathway base, recording upstream and downstream products of a compound and prices, synthetic pathways, synthetic conditions and yields of the upstream and downstream products;
a historical transaction base, recording trade commodities, times and prices of all transactions and current supplier's offer of each said commodity; and
a price calculating system, storing equations for calculating compound current cost price, synthetic pathway price, standard synthetic pathway prices, single pathway price ratios, total pathway price ratios and suggested prices.

2. A compound-price calculating method, at least comprising the following steps:
(1) computing a current cost price of a target compound based on historical trade prices or current supplier's offers of upstream compounds of the target compound;
(2) where the target compound has multiple synthetic pathways, computing synthetic pathway prices of the target compound based on the costs of the upstream compounds and the yields of the target compound of all the synthetic pathways, and selecting the lowest synthetic pathway price as a standard synthetic pathway price;
(3) according to the standard synthetic pathway price and the current cost price, computing a single pathway price ratio, which is a proportion of the standard synthetic pathway price to the current cost price; and according to the multiple said single pathway price ratios, computing a total pathway price ratio; and
(4) obtaining a final suggested price of the target compound from the standard synthetic pathway price and the total pathway price ratio.

3. The compound-price calculating method of claim 2, being characterized in that Step (1) further comprising: computing an average of the multiple historical trade prices of the upstream compounds as a standard historical trade price of the target compound:
Standard Historical Trade Price=Sum (Historical Trade Price 1+Historical Trade Price 2+ . . . +Historical Trade Price n)/(n);
computing an average of the multiple supplier's offers of the upstream compounds as a standard supplier's offer of the target compound:
Standard Supplier's Offer=Sum(Supplier's Offer 1+Supplier's Offer 2+ . . . +Supplier's Offer n)/(n); and
taking the standard historical trade price or the standard supplier's offer as the current cost price of the target compound.

4. The compound-price calculating method of claim 2, being characterized in that in Step (2), the synthetic pathway price of the target compound is computed as below:
Synthetic Pathway Price=Sum(Compound's Cost Price 1+Compound's Cost Price 2+ . . . +Compound's Cost Price n)*(1−Yield %)/(n); and
the standard synthetic pathway price of the target compound is computed as below:
Standard Synthetic Pathway Price=Min (Synthetic Pathway Price 1, Synthetic Pathway Price 2, Synthetic Pathway Price 3, . . . ).

5. The compound-price calculating method of claim 2, being characterized in that in Step (3),
Single Pathway Price Ratio=Standard Synthetic Pathway Price/Historical Trade Price; and
Total Pathway Price Ratio=Sum(Single Pathway Price Ratio 1+Single Pathway Price Ratio 2+ . . . +Single Pathway Price Ratio n)/(n).

6. The compound-price calculating method of claim 2, being characterized in that in Step (4), the suggested price is obtained from the equation of:
Suggested Price=Standard Synthetic Pathway Price/Total Pathway Price Ratio.
